(19) United States
(12) Patent Application Publication
(10) Pub. No.: US 2026/0259935 A1
(43) Pub. Date: Sep. 3, 2026

(54) INCREMENTAL QUERY METHOD AND APPARATUS FOR GRAPH DATA

(71) Applicant: Alipay (Hangzhou) Digital Service Technology Co., Ltd., Hangzhou (CN)

(72) Inventors: Fanshu LIAO, Hangzhou (CN); Litao LIN, Hangzhou (CN); Chuntao HONG, Hangzhou (CN)

(21) Appl. No.: 19/553,127

(22) Filed: Feb. 27, 2026

(30) Foreign Application Priority Data
Feb. 28, 2025 (CN) 202510237889.3

(51) Int. Cl. G06F 16/903; G06F 16/901

(52) U.S. Cl. CPC G06F 16/90335; G06F 16/9024

(57) ABSTRACT

Implementations of the present specification provide an incremental query method for graph data, including: determining a target graph query related to an N-hop query; obtaining incremental graph data including several incremental edges and incremental nodes connected to the incremental edges; performing N-hop neighbor expansion by using an incremental node as a start point to obtain an expanded subgraph; and performing matching for the target graph query in the expanded subgraph to obtain a query result.

### TECHNICAL FIELD

One or more implementations of the present specification relate to the field of computer data query technologies, and in particular, to an incremental query method and apparatus for graph data.

### BACKGROUND

With the development of big data and artificial intelligence, graph structure data (referred to as “graph data” for short below) is used to record and process service data in increasingly more scenarios by virtue of an efficient expression capability of the graph structure data for complex relationships. For example, in a social platform, graph data is used to describe social relationships between users; and in a payment platform, graph data is used to construct complex payment relationship graphs. To make full use of the potential of graph data, a graph data query language is designed in the industry, and the graph data can be queried and analyzed by using a graph database to execute graph query statements.

In practice, graph data massively and dynamically change during execution of a graph query. For example, graph data constructed based on a specific service scenario is not static and unchanged, but is continuously updated with continuous generation of service data. It is difficult to completely process large-scale graph data in one graph query. Typically, graph data are divided and dynamically queried in batches. During execution of a graph query, a dynamic change of graph data makes it difficult to ensure real-time performance and accuracy of graph query results.

When graph data changes, an existing graph database usually re-executes a graph query statement on updated graph data, which not only causes waste of computing resources, but also slows down an execution speed of a graph query, making it difficult to satisfy a service scenario with a relatively high requirement for real-time performance.

### SUMMARY

One or more implementations of the present specification describe an incremental query method and apparatus for graph data. Subgraph expansion is performed based on incremental graph data, and a graph query is executed in a subgraph, to avoid full graph computation caused by the incremental graph data, and effectively prevent computing resources from being wasted on repeated node and path searches, thereby improving execution performance of the graph query and resolving the above technical problem.

According to a first aspect, an incremental query method for graph data is provided, including: determining a target graph query related to an N-hop query; obtaining incremental graph data including several incremental edges and incremental nodes connected to the incremental edges; performing N-hop neighbor expansion by using an incremental node as a start point to obtain an expanded subgraph; and performing matching for the target graph query in the expanded subgraph to obtain a query result.

In an implementation, the target graph query does not include a constraint that restricts a start node to a single designated node.

In an implementation, a value of N is greater than or equal to 2 and less than a predetermined first threshold.

In an implementation, the incremental graph data is a latest batch of graph data streamed to a graph database.

In an implementation, a graph database storing the graph data obtains incremental data corresponding to a predetermined time window at an interval of the predetermined time window; and the incremental graph data is incremental data in a recent time window.

In an implementation, the performing N-hop neighbor expansion to obtain the expanded subgraph includes: performing N rounds of message propagation, where a single round of message propagation includes propagating a first message from a first node to a neighboring node of the first node, where in a first round of message propagation, the incremental node is the first node, and in a non-first round of message propagation, a node that receives the first message in a previous round is the first node; and incorporating nodes and edges related to the N rounds of message propagation into the expanded subgraph.

In a scenario of the above implementation, the first message includes a sender ID; and the non-first round of message propagation includes: determining a target neighboring node of any first node, where the target neighboring node is a neighboring node of the first node, and a node ID of the target neighboring node is different from the sender ID included in the first message received by the first node; and sending the first message from the first node to the target neighboring node, where a node ID of the first node is used as the sender ID.

In an implementation, the performing matching for the target graph query to obtain the query result includes: performing N-hop traversal in the expanded subgraph based on a query condition in the target graph query; and determining the query result based on a result of the N-hop traversal.

In a scenario of the above implementation, the N-hop traversal includes: adding a first marker in a traversal step in response to traversing the incremental edge.

The determining the query result includes: selecting, as a result path, a path that includes the first marker from a traversal path that satisfies the query condition.

In an example of the above scenario, after the adding the first marker, the method further includes: keeping recording the first marker in each subsequent traversal step.

According to a second aspect, an incremental query apparatus for graph data is provided. The apparatus includes: a determining module, configured to determine a target graph query related to an N-hop query; an acquisition module, configured to obtain incremental graph data including several incremental edges and incremental nodes connected to the incremental edges; an expansion module, configured to perform N-hop neighbor expansion by using an incremental node as a start point to obtain an expanded subgraph; and an execution module, configured to perform matching for the target graph query in the expanded subgraph to obtain a query result.

According to a third aspect, a computer program product is provided, including a computer program/instructions, where when the computer program/instructions are executed by a processor, the steps of the method according to the first aspect are implemented.

According to a fourth aspect, a computing device is provided, including a memory and a processor, where the memory stores executable code, and when the processor executes the executable code, the method according to the first aspect is implemented.

In summary, according to the above method and apparatus disclosed in the implementations of the present specification, after incremental graph data is obtained, an expanded subgraph that may generate an incremental query result can be determined based on an incremental edge and an incremental node. When a graph query is executed, only graph matching that satisfies a query condition is performed in the expanded subgraph, to implement an incremental query for graph data, and avoid full graph computation caused by the incremental graph data, thereby improving execution performance of the graph query.

### BRIEF DESCRIPTION OF DRAWINGS

To describe the technical solutions in the implementations of the present invention more clearly, the following is a brief introduction of the accompanying drawings for illustrating such technical solutions. Clearly, the accompanying drawings in the following description are merely some implementations of the present invention. A person of ordinary skill in the art can still derive other drawings from such accompanying drawings without making innovative efforts.

FIG. 1 is example graph data according to the present specification;

FIG. 2 is a schematic diagram illustrating execution of a graph query in an example streaming computation scenario according to the present specification;

FIG. 3 is an architectural diagram illustrating a method for executing an incremental query for graph data according to the present specification;

FIG. 4 is a flowchart illustrating an incremental query method for graph data according to an implementation of the present specification;

FIG. 5 is a schematic diagram illustrating streaming acquisition of incremental graph data according to an implementation of the present specification;

FIG. 6 is an example illustrating determining of a node and an edge of incremental graph data according to an implementation of the present specification;

FIG. 7 is a schematic diagram illustrating expanded subgraph extraction according to an implementation of the present specification; and

FIG. 8 is a schematic diagram illustrating an incremental query apparatus for graph data according to an implementation of the present specification.

### DESCRIPTION OF EMBODIMENTS

The following describes, with reference to the accompanying drawings, the solutions provided in implementations of the present specification.

A graph query language (GQL) can be used to standardize writing of a graph query statement for performing retrieval on graph data. Currently, common graph query languages include Cypher, Gremlin, SPARQL, etc. Syntax and functions of languages are different, but all the languages can process graph data to complete a graph query task. To unify the graph query languages, the ISO/IEC standardization organization has established the GQL standard (ISO/IEC 39075:2024) as the standard graph query language specification.

In one or more implementations of the present specification, a graph query written based on the GQL is used as an example to describe a repeated computation problem that may occur during execution of a graph query in the face of dynamic graph data, and describe a technical solution that can resolve the problem. It should be noted that, although in some implementations of the present specification, the GQL graph query language specification is used for description, this does not represent a limitation on an application scenario and a technical tool in implementations of the present invention. The technical concepts embodied in the implementations of the present specification can be applied to any other graph database that supports any other graph query language.

A graph database is a new type of database implemented based on graph theory. The graph database mainly includes a data storage module for storing graph data and a graph query engine for querying graph data. An atomic object operated in the graph database is a basic element of a graph in the graph theory: a node and a connection edge.

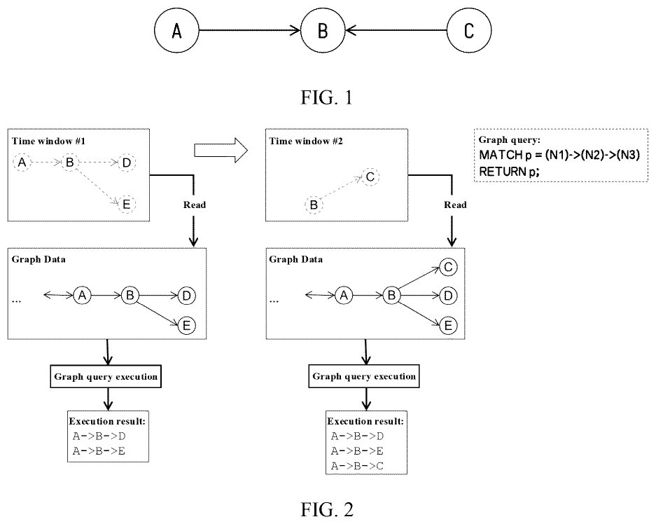

FIG. 1 discloses example graph data. For ease of description, in this example, a node and a label and an attribute on a connection edge are omitted, and each node in the graph is numbered with a letter. In the following description, a connection edge between nodes is represented by <source node, destination node>, and a direction of the connection edge points from the source node to the destination node.

Referring to the accompanying drawing, the graph data includes a node (shown by a circle) and a connection edge (shown by an arrow line). On the graph data, a graph query statement can be executed to perform operations such as data mining, relationship analysis, and path searching. The graph query statement is a query statement written in compliance with a specific graph query language specification. In an example, the graph query statement can be written in a graph query language of the GQL standard. An example is shown below.

$$MATCH p = ( N 1 ) - [ E 1 ] \to ( N 2 ) RETURN p$$

“( )” is an identifier symbol corresponding to a node, and identifiers N1 and N2 located in the identifier symbol are variables representing the node; “[ ]” is an identifier symbol corresponding to a connection edge, and an identifier E1 located in the identifier symbol is a variable representing the connection edge; and “-[E1]->” indicates that a connection edge between the nodes N1 and N2 is a directed edge E1, where a source node is N1, and a destination node is N2. Similarly, it can be learned that, in the graph query statement, the connection edge can additionally or alternatively be limited to another direction: “(N1)<-[E1]-(N2)” represents a directed edge E1 with a source node N2 and a destination node N1; and “(N1)-[E1]-(N2)” represents an undirected edge E1 between the nodes N1 and N2.

The graph query can be executed to obtain several subgraphs through matching from graph data to be queried. A RETURN clause can return an identified result in a predetermined form. For example, “RETURN p” returns a matched subgraph in a path form. If the graph query statement in the above example is executed on the graph data shown in FIG. 1, query results A->B and C->B are obtained.

In addition, the RETURN clause can also include several query fields, for example, “RETURN N1.name” returns a name attribute value corresponding to the query variable node N1 in a subgraph that satisfies a query condition.

In some examples, a filtering query can additionally or alternatively be performed on a label or an attribute of a node to anchor a specific node in the graph data. An example is shown below.

$$MATCH p = ( N 1 ) - [ E 1 ] \to ( N 2 ) WHERE N 1. id = \$ id RETURN p$$

For a chained programming feature of the graph query language, the graph query statement in the example is also equivalent to the following statement:

$$MATCH p = ( N 1 : \{ id : \$ id \} ) - [ E 1 ] \to ( N 2 ) RETURN p$$

“{ }” is an identifier symbol corresponding to an attribute, and an attribute filtering condition is located in the identifier symbol. The graph query statement matches the following subgraph path in graph data to be queried: Two nodes connected by a directed edge, where an ID attribute value of a source node is $id.

Brief descriptions of some example queries in the graph query are provided above. In actual practice, the graph query statement can further include other clauses, such as LIMIT, DISTINCT, CASE, etc. Examples of those other clauses are not listed herein for simplicity in the present specification.

According to the description herein, in example implementations, when service data is established and stored in a form of graph data, during execution of a graph query, a change of service data or batch reading of graph data may cause frequent update of the graph data. This dynamic change of graph data usually results in repeated computation of a graph data query by a graph database. A process of generating this problem is described below by using streaming computation in an example application as an example.

In a streaming computation scenario, data is usually not read in one time, but read continuously and dynamically in batches. For example, with generation of service data, new nodes and connection edges are generated accordingly. The new node and edge data constitutes incremental graph data, and is gradually read into a graph database in a form of a data stream. Alternatively or additionally, the graph database can pull or receive newly generated node and edge data at an interval of certain time (for example, one hour) (or referred to as a time window) from a service system to form incremental graph data. Generally, the incremental graph data is temporarily stored in a form of a temporary graph, etc. after being read into the graph database. When a certain condition is satisfied, the incremental graph data is superposed on current full graph data, to obtain full graph data of an updated version.

In an aspect, some graph queries are performed repeatedly a plurality of times, or a query result is updated in response to arrival of incremental graph data. For such a graph query, if graph traversal and matching are performed on updated full graph data again each time, a large quantity of computing resources are consumed, and a query result is also repeated with historical data, which causes repeated computation, especially when large-scale graph data is processed, this problem is more prominent.

FIG. 2 illustrates execution of a graph query in a streaming computation scenario.

Referring to the accompanying drawing, time window #1 and time window #2 are two data reading nodes that are sequentially generated in a time sequence. Numbers of time windows are only used to represent a relative order between the time windows, and does not represent any specific time window. In example implementations, there can be a plurality of time windows. In this example, only two windows are used as examples for description purposes.

A graph query statement in the example is MATCH p=(N1)->(N2)->(N3) RETURN p.

The query is intended to find a non-loop chain path including three nodes and two consecutive directed edges in graph data.

After the graph database updates streaming data in time window #1, the graph query is executed on the graph data to obtain execution results: A->B->D and A->B->E. After time window #2 arrives, a streaming data increment in the time window is updated to the graph database, that is, node C and a directed edge between nodes B and node C are added. In this case, the graph query is executed again to update a query result. Generally, a new round of complete traversal is performed on all nodes and edges of an entire graph, and all the nodes and edges are re-computed to obtain execution results A->B->D, A->B->E, and A->B->C. This conventional full computation processing manner can ensure correctness of an execution result, but a large amount of repeated computation inevitably generates additional overheads, slows down an execution speed of the graph query, making it difficult to satisfy a service scenario with a relatively high requirement for real-time performance.

The inventors found that incremental node and edge data included in streaming data only generate, in a subgraph with a limited range, an incremental query result that satisfies a graph query condition, without affecting a historical query result. This means that a large amount of computing power is wasted in repeated computation of a historical query result in a conventional full computation manner. Therefore, such execution overheads can be optimized by using technical means. Implementations of the present specification provide incremental graph query solutions, which, among others, reduce overheads in an incremental update scenario. Example technical solutions are described below in detail.

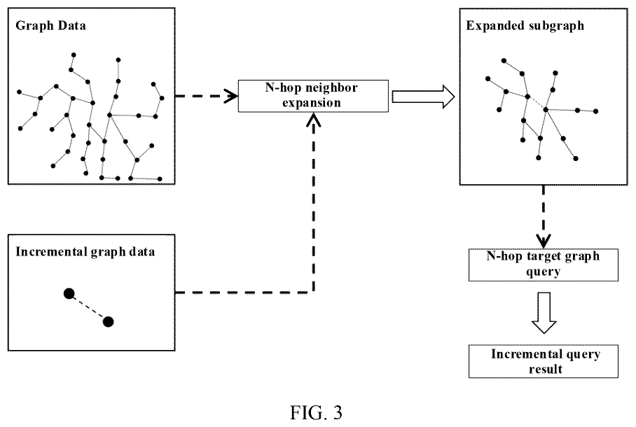

FIG. 3 shows an architecture of a method for executing an incremental query for graph data. A target graph query is a query statement for graph data intended to match a query statement with an N-hop path, and is referred to as an N-hop target graph query for short. In addition, it can be understood that the graph data shown in the accompanying drawing is merely an example for description. In example implementations, the graph data is constructed based on service data, and includes a large quantity of nodes and a more complex connection relationship. Similarly, the incremental graph data shown in the accompanying drawing is also only used as an example for description. In example implementations, incremental graph data included in streaming data is not limited to one incremental edge and two incremental nodes connected to the incremental edge.

Referring back to FIG. 3, an edge included in the incremental graph data is referred to as an incremental edge, and a node connected to the incremental edge is referred to as an incremental node. After the incremental graph data is obtained, N-hop neighbor expansion is performed on the incremental node with reference to the existing graph data and the hop count N of the target graph query, to determine a subgraph, which is referred to as an expanded subgraph. The expanded subgraph can cover all incremental changes caused by the incremental graph data. Therefore, when the target graph query is executed, retrieval and matching are performed only in the expanded subgraph to obtain an incremental query result that satisfies a query condition. Clearly, in the example method, an execution range of the target graph query is limited to the expanded subgraph with a limited range, thereby avoiding full graph retrieval on the graph data, implementing an incremental query on the graph data, reducing computing resources, and improving query efficiency. This query policy, especially when an incremental query is executed on large-scale graph data, can significantly reduce unnecessary repeated matching computation and improve execution performance of a graph query.

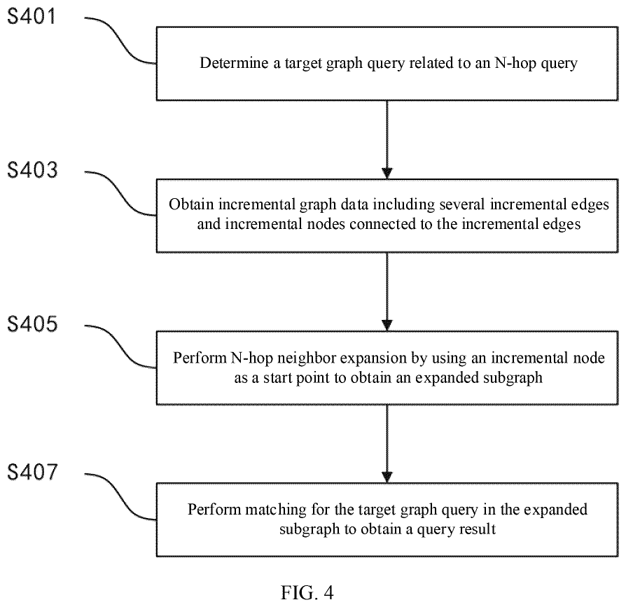

Following the above technical concept, FIG. 4 shows a flowchart illustrating an incremental query method for graph data according to an implementation of the present specification. It can be understood that the method can be performed by using a query engine in a graph database. The query engine can be implemented by any apparatus, device, platform, or device cluster having computing and processing capabilities. Referring to FIG. 4, the method includes at least the following acts: S401: Determine a target graph query related to an N-hop query. S403: Obtain incremental graph data including several incremental edges and incremental nodes connected to the incremental edges. S405: Perform N-hop neighbor expansion by using an incremental node as a start point to obtain an expanded subgraph. S407: Perform matching for the target graph query in the expanded subgraph to obtain a query result.

Example execution manners of the above acts are described below in detail with reference to the accompanying drawings.

Act S401: Determine a target graph query related to an N-hop query.

As described above, the target graph query is usually expressed in a graph query statement written in compliance with a graph query language specification (for example, GQL), and specifically describes information (that is, a query result) that a user wants to retrieve from graph data, including but not limited to, a subgraph, a path, and a node. In this act, a graph query statement entered by a user can be received as the target graph query. Alternatively or additionally, a graph query for which a database system performs matching previously and whose query result currently needs to be updated can be determined as the above target graph query.

A hop count of a graph query refers to the number of connection edges that pass from a start node to an end node in a result path obtained from the graph data query based on a graph query constraint. The start node refers to a node element in the initial position in the graph query path constraint, and the end node refers to a node element in the last position.

In an example, the graph query statement is MATCH p=(N1)->(N2) RETURN p. The start node is N1, the end node is N2, and one connection edge is included between the two nodes. Therefore, the graph query is a 1-hop query, that is, N=1.

In example, the graph query statement is MATCH p=(N1)->(N2)->(N3) RETURN p. The start node is N1, the end node is N3, and two connection edges are included between the two nodes. Therefore, the graph query is a 2-hop query, that is, N=2.

By analogy, it is not difficult to learn that, in a graph query path constraint in which connection edges (that are all outgoing edges or all incoming edges relative to a node variable on a left side of a connection edge identifier) are sequentially connected in series in a single direction, the number of connection edge identifiers is a hop count N of the graph query. However, it should be noted that in some practice, the graph query path constraint may include connection edge identifiers in different directions (mixing of an outgoing edge and an incoming edge or an undirected edge), for example, the following graph query statement:

$$MATCH p = ( N 1 ) \to ( N 2 ) ← ( N 3 ) - ( N 4 ) RETURN p$$

In such a graph query, a start node is a node element in the initial position in a path constraint, e.g., N1, and an end node is a node element in the last position, e.g., N4. Each connection edge identifier included between two nodes is counted as one hop regardless of a direction. Therefore, the graph query in the example is a 3-hop query, that is, N=3.

In addition, in some equivalent expressions of the graph query statement, a value of N can alternatively or additionally be determined based on a quantifier (Quantifier) variable in a path constraint, for example, the following graph query statement:

$$MATCH p = ( N 1 ) - {[}^{*} 3 ] \to ( N 2 ) RETURN p or its equivalent expression$$

$$MATCH p = ( ( N 1 ) - [ ] \to ( N 2 ) ) \{ 3 \} RETURN p$$

In such a graph query, the number 3 is a quantifier, and indicates that in a result path, there are three directed edges between a start node N1 and an end node N2. Therefore, a hop count in the example graph query statement can be determined based on the hop quantifier variable, that is, N=3.

In descriptions of the implementations of the present specification, a graph query statement whose connection edge is an outgoing edge is used as an example for description. However, the related technical ideas can be equivalently inferred and applied to execution of other graph query statements including a directed/undirected connection edge.

In act S403, incremental graph data is obtained, which includes several incremental edges and incremental nodes connected to the incremental edges.

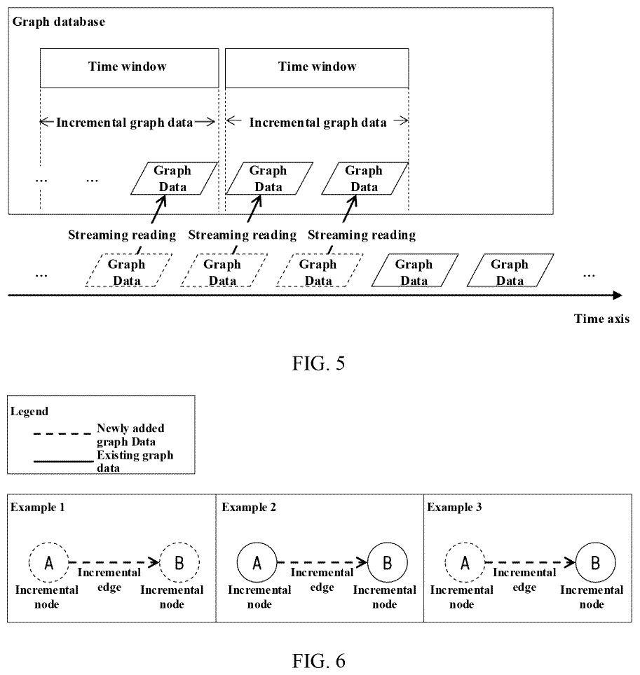

As described herein, in a streaming computation scenario, newly added graph data is not all loaded into a graph database at one time, but is read into the graph database in batches over time. FIG. 5 discloses a schematic diagram illustrating streaming acquisition of incremental graph data.

Referring to the accompanying drawing, over time, new graph data is continuously generated. In a streaming computation framework, the graph data is read into the graph database in batches as streaming data. In some example implementations, the incremental graph data is a latest batch of graph data streamed to the graph database. For example, when a batch of graph data is read into the graph database, the batch of graph data can be used as the incremental graph data for execution of a graph query. In some implementations, generation of graph data does not have a clear batch boundary. For example, graph data generated with update of production environment service data is not fixed in terms of data generation frequency, and does not have a clear batch division condition. In this case, a fixed time interval can be predetermined. Each time interval is considered as a time window, and graph data generated and read in the time window is incremental graph data. Referring to FIG. 5, a graph database storing the graph data obtains incremental data corresponding to a predetermined time window at an interval of the predetermined time window; and the incremental graph data is incremental data in a recent time window.

It should be noted that, a concept of the incremental graph data is described herein by using generation of new graph data as an example, but this does not represent a limitation on an application scenario. For example, even if no new graph data is generated, a streaming computation framework can be applied to existing graph data, and the graph data is read into a graph database/graph query engine in batches.

In an example, graph data targeted by the target graph query is a large-scale graph, and I/O throughput of a system is insufficient to support one-time reading. In this case, streaming computation can also be used to divide large-scale graph data into several small batches of subgraph data to be gradually read.

In an example, a target graph can alternatively or additionally be stored in distributed manner in different computing devices by using a graph segmentation technology (for example, node segmentation or edge segmentation). In this case, streaming computation can also be used to gradually read subgraph data stored in different computing devices.

In summary, there are various application scenarios in which incremental graph data is generated, which are not listed one by one in this implementation of the present specification.

The incremental graph data can include a connection edge, a node, or a combination of a node and a connection edge. In this implementation of the present specification, the connection edge in the incremental graph data is considered as an incremental edge, and all nodes connected to the incremental edge are considered as incremental nodes, even if the node already exists in existing graph data.

FIG. 6 illustrates an example of determining an incremental edge and an incremental node in different incremental graph data. Referring to a part (example 1) shown on a left side of FIG. 6, when both a connection edge and a node included in the incremental graph data are newly added data, the connection edge and the node can be respectively determined as an incremental edge and an incremental node directly. Referring to a part (example 2) shown in the middle of FIG. 6, when the incremental graph data includes only a newly added connection edge and a node is an existing node in historical graph data, the newly added connection edge can be determined as an incremental edge, and all nodes connected to the incremental edge are considered as incremental nodes. Similarly, in a part (example 3) shown on a right side of FIG. 6, an incremental connection edge can be determined as an incremental edge, a newly added node is determined as an incremental node, and another node (an existing node) connected to the incremental edge is also determined as an incremental node.

After the incremental graph data is obtained and the incremental node is determined, in act S405, N-hop neighbor expansion is performed by using an incremental node as a start point to obtain an expanded subgraph.

As described above, for the target graph query, incremental update of graph data usually affects only nodes and edges within a limited range rather than a full graph. By identifying these affected nodes and edges, a target graph query operation can be limited to a local subgraph range, thereby implementing an incremental query for the graph data. These nodes and edges that may be affected by the incremental update can be retrieved by using a topology structure of the graph data. Therefore, in this act, an N-hop neighboring subgraph (that is, the expanded subgraph) of the incremental node is extracted based on the incremental node with reference to the graph data and the hop count N of the target graph query. The N-hop neighboring subgraph not only ensures full coverage of nodes and edges affected by the incremental update, but also can effectively control a subgraph scale.

In some implementations, a conventional graph traversal algorithm can be used, complemented by a limitation on a traversal level (that is, N hops), to extract the expanded subgraph. For example, a breadth first search (BFS) algorithm is used to perform N-level traversal on graph data (including incremental graph data and existing graph data) by using an incremental node as a start point to obtain an N-hop neighboring subgraph of the incremental node as the expanded subgraph.

In some implementations, N-hop expansion of the incremental node can be implemented in a message propagation manner to obtain the expanded subgraph. In the message propagation manner, a scenario with distributed graph storage has a more significant technical advantage. In a distributed scenario, graph data is stored in a plurality of computing nodes, and a graph traversal algorithm additionally designs a traversal synchronization mechanism across computing nodes to adapt to a distributed computing environment. Therefore, the message propagation technology can be used to effectively implement subgraph extraction across computing nodes.

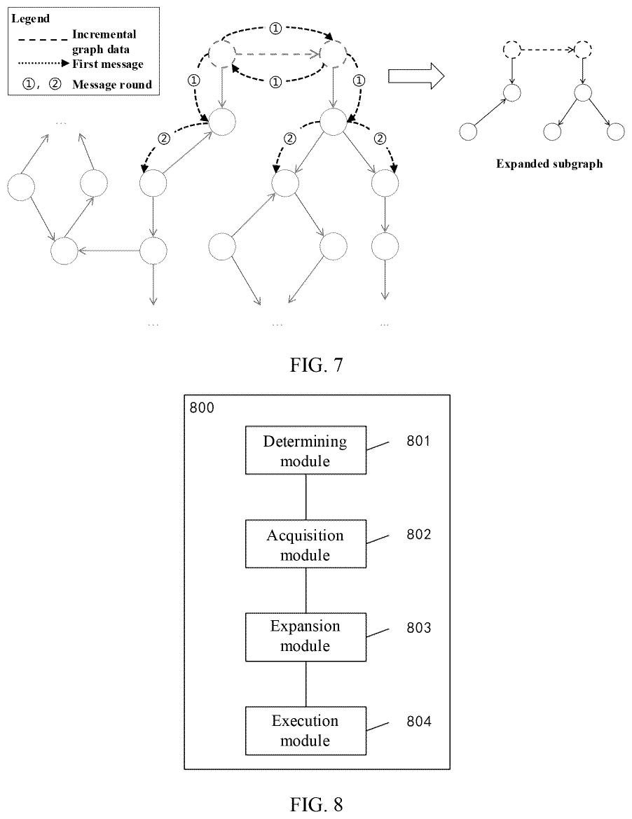

Specifically, to extract the N-hop neighboring subgraph, N rounds of message propagation can be performed by using the incremental node as a start point. A single round of message propagation includes propagating a first message from a first node to a neighboring node of the first node, where in a first round of message propagation, the incremental node is the first node, and in a non-first round of message propagation, a node that receives the first message in a previous round is the first node. Then, nodes and edges related to the N rounds of message propagation are incorporated into the expanded subgraph. FIG. 7 illustrates an expanded subgraph extraction method in this implementation.

Referring to the accompanying drawing, a 2-hop neighboring subgraph (that is, N=2) is used as an example. After the incremental node (a node shown by a dashed line in the accompanying drawing) is determined, the incremental node is used as a start point (that is, the first node) to sequentially send an EvolveMessage (the above first message) to neighboring nodes of the incremental node. The EvolveMessage can be an encapsulated message body that includes node information of the start node, where the node information can be, for example, a unique identifier of a node ID, which is not specifically limited herein. A node that receives the EvolveMessage message continues to send the EvolveMessage message to neighboring nodes of the node as the start node in a new round of message propagation. As such, after N rounds of message propagation, all nodes that receive the EvolveMessage and associated connection edges form an N-hop neighboring subgraph, that is, the expanded subgraph, that uses the incremental node as a start point.

In a process of implementing message propagation, it is also necessary to avoid occurrence of a propagation loop, to avoid occurrence of a dead loop. In some engineering implementations, a sender ID can be included in the first message, and a target neighboring node of any first node is determined in non-first round of message propagation, where the target neighboring node is a neighboring node of the first node, and a node ID of the target neighboring node is different from the sender ID included in the first message received by the first node. The first message is sent from the first node to the target neighboring node, where a node ID of the first node is used as the sender ID.

In other words, the target neighboring node is a destination node to which the first node sends the first message in a current round. When the target neighboring node of the first node is determined, it is necessary to determine whether the neighboring node has sent the first message to the first node. If the neighboring node has sent the first message to the first node, it indicates that the neighboring node has been traversed and cannot be used as the target neighboring node of the first node. In some scenarios, the graph data has a multi-hop loop topology structure. When the target neighboring node is determined, a neighboring node ID being different from any sender ID in all previous first messages received by the first node can be used as a determining condition.

It should be noted that, in this engineering implementation, a node ID is used as a unique identifier for determining the target neighboring node, but does not represent a specific limitation on the unique identifier. In other engineering implementations, other variables that have a unique identification function can alternatively or additionally be used as a determining basis to determine the target neighboring node, which are not listed one by one herein in this implementation of the present specification.

In addition, in some implementations, the target neighboring node can alternatively or additionally be purposefully selected with reference to a path constraint of the target graph query. For example, in the constraint of the target graph query, all connection edges are in a single direction. Because message propagation is performed from a downstream node to an upstream node, a neighboring node connected to a directed edge can be selected as the target neighboring node based on a reverse direction of the single direction.

In an example, the target graph query is as follows: MATCH p=(N1)->(N2)->(N3) RETURN p. In terms of reverse direction (from right to left) of path retrieval, all edges in the path constraint are incoming edges. In each round of message propagation, for the first node, a neighboring node connected to an incoming edge of the node can be determined as the target neighboring node.

Correspondingly, in an example, the target graph query is as follows: MATCH p=(N1)<-(N2)<-(N3) RETURN p. In terms of reverse direction (from right to left) of path retrieval, all edges in the path constraint are outgoing edges. In each round of message propagation, for the first node, a neighboring node connected to an outgoing edge of the node can be determined as the target neighboring node.

The expanded subgraph extraction method is described above. It should be noted that, although the expanded subgraph can limit a retrieval range of the target graph query and improve graph query efficiency, subgraph extraction still consumes certain computing resources. To effectively improve end-to-end execution efficiency of a graph query, it is necessary to comprehensively consider and balance computing resources respectively consumed by expanded subgraph extraction and direct execution of the target graph query. In some scenarios, directly executing the target graph query can obtain a query result more efficiently, that is, implementing an incremental query has a limited effect on improvement of overall query efficiency, and the target graph query can be directly executed to obtain a full query result.

For example, in some scenarios, if a start node is explicitly limited to a uniquely specified node in the target graph query, a node can be uniquely determined from the graph data as the start node of the target graph query. In this case, the target graph query can be directly executed instead of extracting the expanded subgraph for the incremental node. In other words, in this implementation of the present specification, preferably, when the target graph query does not include a constraint that restricts a start node to a single designated node, the above expanded subgraph extraction is performed. The constraint can be a constraint on a unique identifier of a node, for example, a limitation on a node ID in a WHERE clause, or a unique limitation on another attribute of a node. For example, a name attribute of a node is limited in a path constraint: (N1: {name: ($name). Examples are not listed one by one herein.

In some scenarios, when the target graph query defines a target path less than a low hop count threshold (Th1), computing resources consumed by directly executing the target graph query are less than resources consumed by “extracting the expanded subgraph before executing the query”. Correspondingly, in some other scenarios, when the target graph query defines a target path greater than a high hop count threshold (Th2), a scale of an expanded subgraph extracted by using a hop count N as a reference is close to a scale of original graph data, and it is difficult to achieve a target of extracting the expanded subgraph to limit an execution range of the target graph query. Therefore, when the target graph query satisfies any one of the above two scenarios, the target graph query can be directly executed in a graph in which incremental graph data is updated. The above low hop count threshold and high hop count threshold can be thresholds determined based on expert experience. For example, based on practice experience, the low hop count threshold can be set to 2. The high hop count threshold can be set to a threshold by referring to a scale of graph data in different scenarios, for example, 5 hops (in some types of graph data, in principle, any two nodes in a graph can be connected by using 5 hops). In other words, in this implementation of the present specification, a value of N is greater than or equal to 2 and less than a predetermined first threshold.

After the expanded subgraph is obtained by using the act 405, in act S407, matching is performed for the target graph query in the expanded subgraph to obtain a query result.

In this act, the target graph query can be executed only in the obtained expanded subgraph. Because the expanded subgraph covers all nodes and edges that may be affected by incremental update, and the numbers of nodes and edges in the expanded subgraph are far less than the number of nodes and edges in a full graph, an incremental query implemented by using this act reduces unnecessary repeated computation, and greatly improves execution efficiency of the target graph query.

In an implementation, N-hop traversal is performed in the expanded subgraph based on a query condition in the target graph query; and the query result is determined based on a result of the N-hop traversal. In an example, the query condition does not include any limitation on a start node, and therefore, any node in the expanded subgraph can be used as the start node of the query to perform matching for the target graph query. In an example, the query condition includes a plurality of start point constraints (for example, amount attribute filtering of a node: WHERE amount >30), and therefore, a node satisfying the plurality of start point constraints in the expanded subgraph can be used as the start node of the query to perform matching for the target graph query. In an example, a purposeful N-hop traversal can alternatively or additionally be performed based on various other constraints included in the target graph query, to further reduce computing resources. Examples are not listed one by one herein in this implementation of the present specification.

In the above implementation, several target paths that satisfy the query condition can be retrieved from the expanded subgraph based on the query condition in the target graph query. Compared with a historical query result for the graph data, these target paths include incremental query results that satisfy the query condition introduced into the incremental graph data, and may also include some target paths that overlap the historical query result. Therefore, to implement the incremental query, the query result can be compared with the historical query result, and a redundant path is removed from the query result through set difference calculation (for example, a set difference operation, target path coverage check, etc.) to obtain an incremental query result.

In some engineering implementations, an incremental query result can be selected by comparing target paths in a traversal query result set with those in a historical query result set. Time complexity of the engineering implementation is O(n²).

Because a target path corresponding to the incremental query result is generated by adding the incremental graph data, each incremental target path includes at least one incremental edge. Whether the incremental edge exists can be used to determine whether the target path belongs to the incremental query result. Based on this, in some engineering implementations, in the N-hop traversal process, a dynamic marker, referred to as a first marker for short below, can be added to a traversal step in response to traversing the incremental edge. After the N-hop traversal is completed, a path that includes the first marker is selected as a result path, that is, the incremental query result, from a traversal path that satisfies the query condition.

The first marker can be a Boolean variable, or can be a marker variable in another form, and is used to identify existence of the incremental edge in the target path. Any specific implementation of the first marker is possible and none of them limit the scope of specification. In this engineering implementation, the first marker is added to the target path with execution of the N-hop traversal. Therefore, after the N-hop traversal is completed and the query result is obtained, the target path with the first marker, that is, the incremental query result, can be selected by traversing a query result set. Time complexity of the engineering implementation is O(n).

In addition, in some implementations, graph data is stored in a distributed manner in several computing nodes. In this scenario, in the above engineering implementation, cross-node data reading is performed to obtain a basis (the first marker) for determining an incremental query result. To optimize this process, in an engineering implementation, in the N-hop traversal process, after the first marker is added, the first marker can be kept as a record in each subsequent traversal step. As such, unnecessary cross-node reading can be reduced in a process of selecting an incremental query result, thereby improving selection efficiency. For example, when the first marker is transmitted to an end node of a target path that satisfies the query condition with execution of the N-hop traversal, the target path with the first marker can be identified immediately as an incremental query result. On the contrary, when the first marker is not added/transmitted when the N-hop traversal is performed at the end node of the target path that satisfies the query condition, the target path is repeated with a record in a historical query result and does not belong to the incremental query result. Time complexity of the engineering implementation is O(1).

Description of a main procedure of an incremental query method for graph data provided in the implementations of the present specification is described above. Although in the above implementation, a graph query statement of a GQL standard and a graph database corresponding to the graph query statement are mainly used as an example to describe the method procedure, a technical concept embodied therein can also be applied to another graph database and an execution process of a related graph query statement.

According to the above method provided in the implementations of the present specification, after incremental graph data is obtained, an expanded subgraph that may generate an incremental query result can be determined. When a graph query is performed, only graph matching that satisfies a query condition is performed in the expanded subgraph, to implement an incremental query of graph data, and avoid full graph computation, thereby improving execution performance of the graph query.

In the present specification, “first” in words such as a first node and a first message, and a corresponding “second” (if present) and “third” in the present specification are merely for distinguishing and easy description, and do not have any limiting significance.

The above content describes example implementations of the present specification, and other implementations fall within the scope of the appended claims. In some cases, the actions or steps described in the claims can be performed in a sequence different from that in some implementations and the desired results can still be achieved. In addition, the process depicted in the accompanying drawings does not necessarily require the shown particular order or sequence to achieve the desired results. In some implementations, multi-tasking and parallel processing are feasible or may be advantageous.

FIG. 8 is a schematic diagram illustrating an incremental query apparatus for graph data according to an implementation of the present specification. The apparatus 800 is deployed in a computing device, and the computing device can be implemented by any apparatus, device, platform, device cluster, etc. that has a computing and processing capability. This apparatus implementation corresponds to the method shown in FIG. 4. The apparatus 800 includes: a determining module 801, configured to determine a target graph query related to an N-hop query; an acquisition module 802, configured to obtain incremental graph data including several incremental edges and incremental nodes connected to the incremental edges; an expansion module 803, configured to perform N-hop neighbor expansion by using an incremental node as a start point to obtain an expanded subgraph; and an execution module 804, configured to perform matching for the target graph query in the expanded subgraph to obtain a query result.

According to an implementation in another aspect, the present specification further provides a computer program product, including a computer program/instructions. When the computer program/instructions are executed by a processor, the steps of the method described above with reference to FIG. 4 are implemented.

According to an implementation in still another aspect, the present specification further provides a computing device, including one or more memory devices and one or more processors. The memory stores executable code, and when the processor executes the executable code, the steps of the method described above with reference to FIG. 4 are implemented. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively. The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

A person skilled in the art should be aware that, in the above one or more examples, the functions described in the implementations of the present invention can be implemented by hardware, software, firmware, or any combination thereof. When software is used for implementation, these functions can be stored in a computer-readable medium or transmitted as one or more instructions or code on the computer-readable medium.

The objectives, technical solutions, and beneficial effects of the implementations of the present invention are further described in detail in the above example implementations. It should be understood that the above descriptions are merely example implementations of the implementations of the present invention, but are not intended to limit the protection scope of the present invention. Any modification, equivalent replacement, improvement, etc. made based on the technical solutions of the present invention shall fall within the protection scope of the present invention.

What is claimed is:

1. A method for querying graph data, comprising:
determining a target graph query related to an N-hop query;
obtaining incremental graph data including an incremental edge and an incremental node connected to the incremental edge;
performing N-hop neighbor expansion by using the incremental node as a start point to obtain an expanded subgraph; and
performing matching for the target graph query in the expanded subgraph to obtain a query result.

2. The method according to claim 1, wherein the target graph query does not include a constraint that restricts a start node to a single designated node.

3. The method according to claim 1, wherein a value of N is greater than or equal to 2 and less than a first threshold.

4. The method according to claim 1, wherein the incremental graph data is a latest batch of graph data streamed to a graph database.

5. The method according to claim 1, wherein a graph database storing the graph data obtains incremental data corresponding to a time window at an interval of the time window; and
the incremental graph data includes incremental data in a recent time window.

6. The method according to claim 1, wherein the performing N-hop neighbor expansion to obtain the expanded subgraph includes:
performing N rounds of message propagation, wherein each round of message propagation includes propagating a first message from a first node to a neighboring node of the first node, wherein in a first round of message propagation, the incremental node is the first node, and in a subsequent round of message propagation subsequent to the first round, a node that receives the first message in a previous round is the first node; and
incorporating nodes and edges related to the N rounds of message propagation into the expanded subgraph.

7. The method according to claim 6, wherein the first message includes a sender ID; and the subsequent round of message propagation includes:
determining a target neighboring node of the first node, wherein the target neighboring node is a neighboring node of the first node, and a node ID of the target neighboring node is different from the sender ID included in the first message received by the first node in the previous round; and
sending the first message from the first node to the target neighboring node, wherein a node ID of the first node is used as the sender ID.

8. The method according to claim 1, wherein the performing matching for the target graph query to obtain the query result includes:
performing N-hop traversal in the expanded subgraph based on a query condition in the target graph query; and
determining the query result based on a result of the N-hop traversal.

9. The method according to claim 8, wherein the N-hop traversal includes:
adding a first marker in a traversal step in response to traversing the incremental edge; and
wherein the determining the query result includes:
selecting, as a result path, a traversal path that includes the first marker and satisfies the query condition.

10. The method according to claim 9, further comprising:
after the adding the first marker, recording the first marker in each subsequent traversal step.

11. A computing system, comprising:
one or more processors; and
one or more memory devices having computer executable instructions stored thereon, the computer executable instructions, when executed by the one or more processors, enabling the one or more processors to, individually or collectively, implement actions including:
determining a target graph query related to an N-hop query;
obtaining incremental graph data including an incremental edge and an incremental node connected to the incremental edge;
performing N-hop neighbor expansion by using the incremental node as a start point to obtain an expanded subgraph; and
performing matching for the target graph query in the expanded subgraph to obtain a query result.

12. The computing system according to claim 11, wherein the target graph query does not include a constraint that restricts a start node to a single designated node.

13. The computing system according to claim 11, wherein the incremental graph data is a latest batch of graph data streamed to a graph database.

14. The computing system according to claim 11, wherein a graph database storing the graph data obtains incremental data corresponding to a time window at an interval of the time window; and
the incremental graph data includes incremental data in a recent time window.

15. The computing system according to claim 11, wherein the performing N-hop neighbor expansion to obtain the expanded subgraph includes:
performing N rounds of message propagation, wherein each round of message propagation includes propagating a first message from a first node to a neighboring node of the first node, wherein in a first round of message propagation, the incremental node is the first node, and in a subsequent round of message propagation subsequent to the first round, a node that receives the first message in a previous round is the first node; and
incorporating nodes and edges related to the N rounds of message propagation into the expanded subgraph.

16. The computing system according to claim 15, wherein the first message includes a sender ID; and the subsequent round of message propagation includes:
determining a target neighboring node of the first node, wherein the target neighboring node is a neighboring node of the first node, and a node ID of the target neighboring node is different from the sender ID included in the first message received by the first node in the previous round; and
sending the first message from the first node to the target neighboring node, wherein a node ID of the first node is used as the sender ID.

17. The computing system according to claim 11, wherein the performing matching for the target graph query to obtain the query result includes:
performing N-hop traversal in the expanded subgraph based on a query condition in the target graph query; and
determining the query result based on a result of the N-hop traversal.

18. The computing system according to claim 17, wherein the N-hop traversal includes:
adding a first marker in a traversal step in response to traversing the incremental edge; and
wherein the determining the query result includes:
selecting, as a result path, a traversal path that includes the first marker and satisfies the query condition.

19. The computing system according to claim 18, wherein the actions include:
after the adding the first marker, recording the first marker in each subsequent traversal step.

20. A non-transitory storage medium having computer executable instructions stored thereon, the computer executable instructions, when executed by one or more processors, enabling the one or more processors to, individually or collectively, implement actions including:
determining a target graph query related to an N-hop query;
obtaining incremental graph data including an incremental edge and an incremental node connected to the incremental edge;
performing N-hop neighbor expansion by using the incremental node as a start point to obtain an expanded subgraph; and
performing matching for the target graph query in the expanded subgraph to obtain a query result.
